(19) United States
(12) Patent Application Publication
(10) Pub. No.: US 2006/0100639 A1
(43) Pub. Date: May 11, 2006

(54) System and method for the treatment of reperfusion injury

(75) Inventors: Howard R. Levin, Teaneck, NJ (US); Mark Gelfand, New York, NY (US)

Correspondence Address: NIXON & VANDERHYE, PC, 901 NORTH GLEBE ROAD, 11TH FLOOR, ARLINGTON, VA, 22203, US

(73) Assignee: G&L Consulting, LLC, New York (US)

(21) Appl. No.: 11/267,407

(22) Filed: Nov. 7, 2005

Related U.S. Application Data
(60) Provisional application No. 60/646,517, filed on Jan. 25, 2005.
(60) Provisional application No. 60/625,165, filed on Nov. 5, 2004.

(51) Int. Cl. A61D 1/12

(52) U.S. Cl. 606/106

(57) ABSTRACT

A method and apparatus for the prevention and treatment of reperfusion injury following the reperfusion of acute MI which includes modulation of coronary blood flow or oxygen delivery following the reperfusion of the infarct with a catheter placed in the coronary artery or vein.

### RELATED APPLICATIONS

This application is based upon and claims the benefit of priority from prior U.S. Provisional Application Ser. No. 60/646,517 filed Jan. 25, 2005, and U.S. Provisional Application Ser. No. 60/625,165 filed Nov. 5, 2004, and the entire contents of which are incorporated herein by reference.

### BACKGROUND OF THE INVENTION

This invention relates to a method for reducing reperfusion injury after therapeutic reperfusion of an infarct of a heart or other organ. It also relates to percutaneous transluminal coronary angioplasty PTCA catheters for angioplasty and protection of patients during transcatheter reperfusion therapies.

In patients who suffer from acute myocardial infarction (MI), if the myocardium (heart muscle) is deprived of adequate levels of oxygenated blood for a prolonged period of time, irreversible damage to the heart can result. Modern treatment of acute myocardial infarction or myocardial ischemia often comprises performing angioplasty or stenting of the vessels to increase the size of the vessel opening to allow increased blood flow. Modern therapeutic strategies that restore blood flow, as opposed to just letting the patient rest, are called reperfusion.

Reperfusion, after a short episode of myocardial ischemia (up to 15 min), is followed by the rapid restoration of cellular metabolism and function. Even with the successful treatment of occluded vessels with percutaneous transluminal coronary angioplasty (PTCA) and stenting, a significant risk of additional tissue injury after reperfusion may still occur. If the ischemic episode has been of sufficient severity and/or duration to cause significant changes in the metabolism and the structural integrity of heart muscle, reperfusion may paradoxically result in a worsening of heart function, out of proportion to the amount of dysfunction expected simply as a result of the duration of blocked flow. In a matter of seconds to minutes, reperfusion of the ischemic myocardium can be followed by dramatic functional and structural changes that can lead to additional heart dysfunction and even death.

Reperfusion injury can be defined as the damage that occurs to an organ that is caused by the resumption of blood flow after an episode of ischemia. This damage is distinct from the injury resulting from the ischemia per se. One hallmark of reperfusion injury is that it may be attenuated by interventions initiated before or during the reperfusion. Reperfusion injury results from several complex and interdependent mechanisms that involve the production of reactive oxygen species, endothelial cell dysfunction, microvascular injury, alterations in intracellular Ca2+ handling, changes in myocardial metabolism, and activation of neutrophils, platelets, and the complement system. All of the deleterious consequences associated with reperfusion constitute a spectrum of reperfusion-associated pathologies that are collectively called reperfusion injury. Reperfusion injury occurs in the short period of time immediately following the transition from the metabolic famine to feast. This period is seconds to tens of minutes long and for the purpose of this invention is called “the time of reperfusion (injury)”.

In the last two decades, considerable effort has focused on limiting infarct size and other manifestations of post-ischemic reperfusion injury. In 1986, Murry et al. first introduced the concept of ischemic preconditioning in which repetitive brief periods of ischemia protected the myocardium from a subsequent longer ischemic insult. (Murry CE, Jennings RB, and Reimer KA Preconditioning with ischemia: a delay of lethal cell injury in ischemic myocardium. Circulation 74: 1124-1136, 1986)

Preconditioning succeeded in significantly reducing infarct size at a time when other pharmacological strategies were inconsistent in their effect. Although preconditioning has been clinically successful in attenuating the physiological effects of balloon inflations during percutaneous transluminal coronary angioplasty, its use as a clinical cardioprotective strategy is limited by the inability to predict the onset of ischemia.

Despite spectacular improvements in MI therapy, within one year of the myocardial infarction, 25% of men and 38% of women die. The total number and incidence of heart failure continues to rise with over 500,000 new cases each year. Approximately 85% of these new cases of heart failure are a direct consequence of a large MI. While considerable progress has been made in acute reperfusion of the heart immediately after the MI, reperfusion injury, infarct extension, heart remodeling and infarct expansion that follows is not treated effectively. There is a clear clinical need for a novel treatment that can be applied shortly after the MI at the time of re-opening of the occluded vessel to reduce the extent of reperfusion injury and the infarct extension.

The protection afforded by ischemic preconditioning (preconditioning), in which short periods of ischemia protect the myocardium against a subsequent lethal ischemic insult, can only be used if the preconditioning is applied before the ischemic episode. The ischemic episode and MI are often unpredictable clinically. There is a long felt need for a method and device that protect the heart by intervening at the time of reperfusion.

In particular, there is a clear clinical need for a novel treatment that can be applied shortly after the MI to reduce the extent of the infarct expansion that is minimally invasive and can be performed in a cathlab as an adjunct to PTCA reperfusion that is increasingly a standard of care in acute MI.

### SUMMARY OF THE INVENTION

A system has been developed to reduce the severity and complications of MI by reducing infarct size and extension by moderating reperfusion injury. The invention may be embodied by modulating blood flow (or oxygen delivery) to the reperfused zones of the heart muscle over a short period of time (e.g., seconds to minutes) immediately following the re-opening of the blood vessel thus altering the abrupt transition of the muscle at risk from extremely low to high blood supply. The invention may also reduce reperfusion injury with a procedure that is practical, simple, easily reversible, and minimally invasive (does not require general anesthesia and surgery) that is complimentary to PTCA, stenting and similar catheter based interventions.

A novel method and device have been developed that limits reperfusion injury and infarct size by modulating perfusion of heart muscle perfused by the previously occluded coronary blood vessel immediately following the abrupt reopening of the vessel, such as with a PTCA balloon or by other therapeutic means known in cardiology and cardiac surgery. According to the invention reducing the flow of the perfusate and/or the composition of the perfusate can modulate the perfusion of the heart during the period of reperfusion injury.

In the context of the treatment disclosed herein, any fluid used to perfuse, deliver oxygen and medication to living tissue and wash out metabolic products from the living tissue is called perfusate. Blood is the most common example of a perfusate. Perfusate flows through the vascular system (blood vessels, arteries and veins) urged by a pressure gradient. Perfused tissue is considered ischemic when the perfusion is insufficient to deliver the required amount of oxygen or carry away the products of metabolism.

In the setting of the acute MI, a major blood vessel is typically occluded between 95 to 100% of its diameter, resulting in an immediate and marked reduction in blood flow. Generally, from scientific literature, there is a following relationship between the reduction of blood supply to the heart muscle and the severity of clinical consequences:

0-5% of blood flow—rapid necrosis, certain MI,

5-10% of blood flow—severely ischemic and likely to cause necrosis,

>20% of blood flow—no necrosis but mechanical dysfunction (stunning) of the heart muscle.

PTCA is a standard treatment for coronary artery disease, which occurs when blood flow to the heart is restricted due to hardened, plugged up coronary arteries. In the case of an acute MI, a coronary artery is typically occluded by a blood clot forming on top of a pre-existing fixed blockage/lesion.

PTCA may be performed the following way. The physician uses local anesthetic to numb a specific area of the patient's body, usually the upper thigh area where the femoral artery is. A small tube called a sheath is inserted into an artery, such as the femoral artery. A flexible balloon-tipped plastic catheter approximately 2 mm in diameter and 80 cm long is inserted through the sheath, advanced to the heart and directed to an area of coronary blood vessel narrowing. When the balloon inflates, it displaces the blockage against the vessel wall and reopens the vessel. With the blood flow restored, the balloon catheter is then deflated and removed.

Coronary artery stenting is a catheter-based procedure in which a stent (a small, expandable wire mesh tube or scaffolding) is inserted into a diseased artery to hold open the artery. Its most common use is in conjunction with balloon angioplasty to treat coronary artery disease. After the angioplasty reduces the narrowing of the coronary artery, the stent is inserted to prevent the artery from re-closing. The PTCA catheters are typically single-use only and discarded after the procedure. Stents are left in place in the artery. In the setting of an acute MI, PTCA is usually performed before stenting. Therefore, PTCA will be used as an example in the application of the acute MI reperfusion therapy. It is understood that other, medical devices such as catheter tip lasers, rotating blades and high-pressure fluid jets have been used to reopen coronary blood vessels. It can be envisioned that this invention can be an adjunct to any of these therapies.

In one preferred embodiment, a balloon tipped catheter may be used both as a PTCA dilation balloon and to modulate coronary blood flow in the re-opened artery immediately following the re-opening. The balloon can be, for example, positioned inside the previously occluded coronary vessel at the site of the just-angioplastied coronary lesion or immediately distally or proximally of the former lesion site. The balloon can be rapidly inflated and deflated to interrupt blood flow in the coronary artery supplying the heart muscle at risk of reperfusion injury. The obstacle of the balloon therefore reduces the blood flow to the tissue at risk when the balloon is cyclically inflated by modulating this flow during the period of time of risk for reperfusion injury. The modulation of blood flow may last as little as few seconds to one minute and likely no more than tens of minutes. The modulation should begin immediately after reperfusion (re-opening of the vessel). The reperfusion injury is not per se related to the amount of flow of the perfusate but to the chemical composition of it and in particular to its oxygen content. Based on this observation an alternative preferred embodiment is proposed to perfuse the heart with a perfusate with low oxygen content at the time of reperfusion injury.

Various patterns of blood flow modulation with the oscillating balloon can be envisioned. For example, one could used rapid oscillations of the balloon going from inflated to deflated state every second for two minutes or gradual slow deflation of the balloon thus opening the vessel from 5% of normal blood flow to 50% blood flow over, for example, one minute.

The treatment disclosed herein incorporates several novel features including (without limitation): a) a balloon catheter placed in the re-opened coronary vessel of the acute MI patient at the time of the reopening, b) a balloon modulating arterial coronary blood flow distal of the re-opened occlusion in a short period of time immediately following reperfusion; and c) a balloon modulating venous coronary blood flow in the coronary sinus. The procedure characterized by these elements may be called “balloon post-conditioning”.

The balloon post-conditioning procedure is described herein in regard to the MI or infarct of the heart. It is to be understood that it is equally relevant to the treatment of the reperfusion injury to any organ that suffered from prolong ischemia. For example, if blood vessels supplying arterial blood to the brain are abruptly reopened by a balloon catheter, post-conditioning may be beneficial to reduce the amount of brain injury.

### SUMMARY OF THE DRAWINGS

A preferred embodiment and best mode of the invention is illustrated in the attached drawings that are described as follows:

FIG. 1 illustrates the MI reperfusion by balloon catheter.

FIG. 2 illustrates the timing of post-conditioning.

FIG. 3 illustrates the alternative embodiment of the invention.

FIG. 4 illustrates the alternative embodiment of the invention.

FIG. 5 illustrates an alternative embodiment for post-conditioning using coronary sinus.

FIG. 6 illustrates a controller mechanism for controlling the degree of occlusion of a blood vessel.

FIG. 7 illustrates post-conditioning with a reduced oxygen content perfusate.

FIG. 8 illustrates post-conditioning using a distal guidewire balloon.

FIG. 9 illustrates feedback control of graded post-conditioning using coronary pressure or flow.

FIG. 10 further illustrates post-conditioning by gradual occlusion of the coronary sinus using pressure feedback.

### DETAILED DESCRIPTION OF THE INVENTION

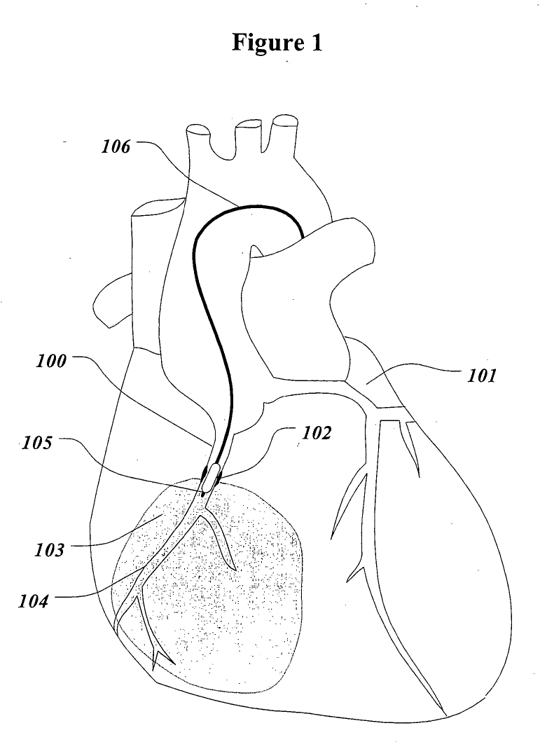

FIG. 1 illustrates treatment of a patient with an oscillating angioplasty balloon following an acute MI. During the MI, coronary artery 100 of the heart 101 is abruptly occluded by the thrombus 102, for example. This treatment described herein of the MI may occur, one to several hours after the MI episode therapy. As a result, a large area 103 of the heart muscle 101 normally perfused by the distal branches 104 of the coronary artery 100 is deprived of oxygen. By the time the patient is reperfused by PTCA, this oxygen deprivation may have lasted one to several hours. This time period of a few hours is sufficient for some tissue to be permanently damaged but a large part of the area 103 at risk may still be saved.

A PTCA balloon 105 is mounted on the tip of the catheter 106 is introduced into the coronary artery 100 until it traverses (crosses) the thrombus 102. The balloon 105 is inflated to a pressure of typically 6-8 atmospheres. The balloon expands and enlarges the artery by compressing the thrombus material and opening the coronary artery. For an artery having a 3 mm nominal diameter, the balloon 105 is expanded to 2.7 to 3.3 mm diameter by inflation to a “nominal” balloon pressure. The inflation of the balloon is actuated by a control console 107 that is external to the patient and connected to the catheter 106. Manufacturers of PTCA balloons supply pressure vs. diameter compliance curves to physicians. For example a typical PTCA balloon may have the following compliance characteristic:

| P (atm) | Diameter (mm) |
|---|---|
| 4.0 | 2.8 |
| 6.0 | 3.0 |
| 12.0 | 3.23 |
| 18.0 | Burst |

It is conventional that after the inflation of the balloon 105, the physician rapidly deflates the balloon and removes it from the coronary artery quickly to allow blood flow to the distal coronary branches 104 and to the zone of the heart muscle 103 that has already has infarcted areas (non-contracting, necrotic tissue that will be replaced by scar tissue) and tissue that is not yet infarcted but is stunned and at risk of infarct. In the prior art, this fresh blood flow after the abrupt removal of obstruction rushes to the stunned tissue at risk of infarction and caused reperfusion injury.

Counterintuitively, and breaking with the established tradition of acute MI therapy, the inventors propose to limit the propagation of the infarct and increase the amount of salvaged tissue in the risk zone 103 by limiting the amount of blood flow to distal coronary branches immediately following re-opening of an occluded coronary artery and reperfusion of the heart tissue. In particular, the flow of blood is modulated so that the blood flow is reduced and controlled to the heart muscle 103 that is at risk.

The same balloon 105 that is used to open the occluded coronary artery 100 is used to control and make the blood flow to the distal branches 104 of the coronary artery and the zone 103 of infarct and at risk. A separate balloon catheter can be used or a second balloon can be mounted on the shaft of the PTCA catheter distal or proximal of the dilatation balloon to control blood flow. Modern techniques well known in the field of interventional cardiology allow rapid exchange of catheters over the wire as well as the construction of catheters with multiple balloons.

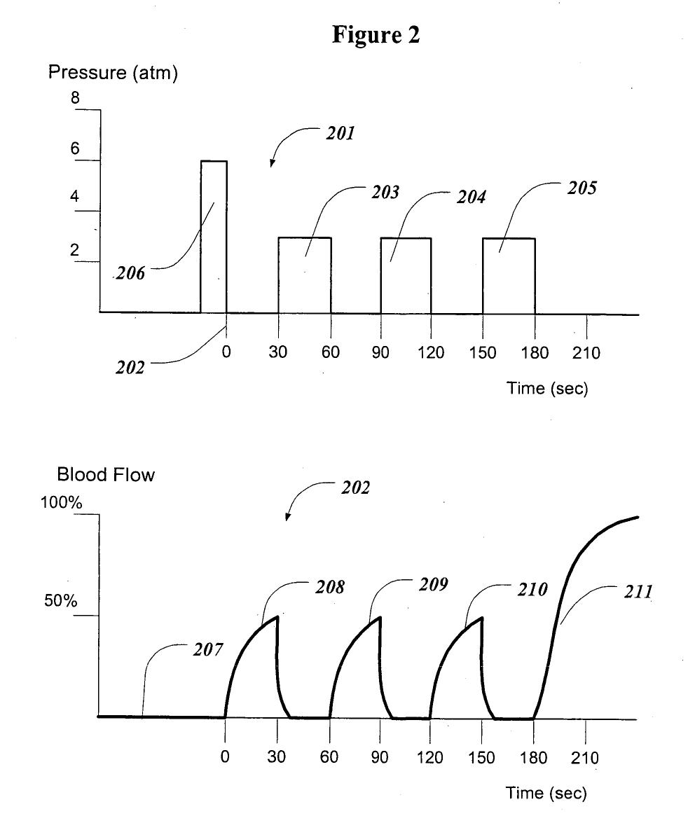

FIG. 2 gives an example of patterns of balloon inflation and distal coronary blood flow during the proposed therapy. Trace 201 illustrates the balloon pressure. Time mark zero 202 corresponds to the opening of the obstruction of the coronary artery, deflation of the PTCA balloon and the beginning of reperfusion. Reperfusion is followed by three cycles of occlusion—reperfusion 203, 204 and 205. In this example, the balloon 105 is inflated first time 206 to the full nominal pressure to disrupt the occlusion and open the artery. Sequentially during the balloon post-conditioning cycles, the balloon is inflated to a lower inflation pressure than that reached during the initial opening of the occlusion in the artery to reduce potential injury to the artery from overdilation while achieving sufficient occlusion of the artery to cause effective termination of the blood flow to the distal branches of the coronary artery (distal flow).

Trace 206 illustrates the anticipated distal coronary blood flow associated with the “balloon post-conditioning” therapy. Prior to reperfusion blood flow 207 is essentially zero. The infarct zone and zone at risk are supplied with oxygen via minor vessels, or so-called collateral arteries. After the opening of the coronary artery, blood flow immediately increases 208 and is later reduced again by the first post-conditioning balloon inflation 212. The following flow pulses 209 and 210 correspond to the release phases of the pulsating balloon. After the last pulse 205, the catheter is removed and the distal flow is increased to its normal level 211.

In regard to FIG. 2, the particular sequence, timing, amplitude and duration of pulses is given as an illustration. It is understood that different patterns of post-conditioning may be beneficial to control reperfusion injury in patients undergoing PTCA procedure to treat acute MI.

It is appreciated that while it is possible to rapidly inflate and deflate the balloon using a standard manual PTCA balloon inflation device, the cycling of the post-conditioning balloon can be automated. If an automatic balloon cycling device is used, the proximal end of the catheter 106 is attached to the inflation control console (not shown). It is understood that different lumens inside the catheter can terminate in separate catheter branches and connect to different devices outside of the patient's body.

The control console 107 includes a balloon inflation device. The inflation device can be a syringe pump or piston type apparatus. Merit Medical Inc. (South Jordan, Utah) offers a wide variety of these type inflation devices for balloon tipped catheters that can be easily adopted for the invention apparatus. For example, Merit Medical manufactures an IntelliSystem 25 Inflation Syringe for balloon catheters catheter used in cardiology to inflate balloons in coronary arteries of the heart. Medical Ventures Corp. (Richmond, BC Canada) manufactures another automatic balloon inflation system that can be adopted for the post-conditioning. The Metricath System uses a console unit and a disposable balloon tipped catheter to provide arterial lumen size measurements. Alternatively, other devices previously used to inflate catheter balloons with compressed gas (such as in Intra-aortic Balloon Pumps) can be used. For example the Datascope's (Datascope Corporation, NJ) CS100 IABP inflates and deflates a much larger intra-aortic balloon up to 185 times per minute using a cylinder with compressed helium and solenoid valves controlled by a microprocessor. Similarly, a cylinder with compressed gas under high pressure (not shown) can be connected to the catheter using a pressure regulator and a control (inflation—deflation) valve. The inflation gas can be helium or carbon dioxide to facilitate rapid inflation and deflation and to ensure safety if the balloon is ruptured.

Inflation and deflation of the balloon by the inflation device can be controlled manually or by computer controls in the console. The console 107 can include solenoid or other type valves, motors, motor control electronics and common safety features. The balloon 105 may be quickly deflated by withdrawing the piston or opening a safety valve (not shown) and venting the balloon. Alternatively, a vacuum can be applied to the balloon inflation lumen of the catheter 106 in order to collapse the balloon rapidly and completely. The actual design of the balloon inflation sub-system can be implemented using known hydraulic and pneumatic elements. The cylical process of rapid inflation-deflation of a balloon catheter can be automated using known technology.

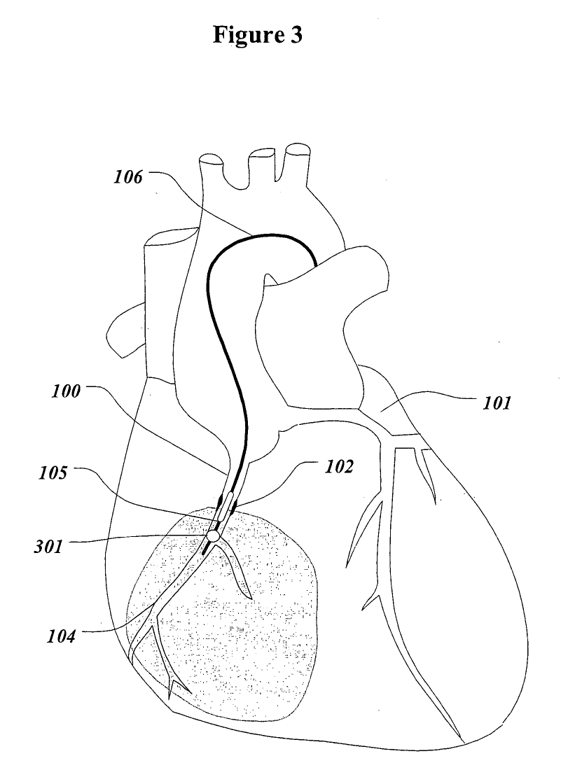

FIG. 3 illustrates an embodiment of the invention where the post-conditioning balloon 301 is separate from the dilatation balloon 105 and located distally on the same catheter shaft. This embodiment is more complex technologically but has several advantages. There are two reasons for putting balloon in this location. Embolization of small pieces of the disrupted occlusion 102 can be carried by the restored blood flow, lodging in more distal coronary arteries and may lead to infarction of the area supplied by that artery. This problem is considered sufficiently important that there are now commercially available methods of distal protection (the prevention of this embolization) during PTCA. It is possible that repeated cycling the PTCA balloon itself 105 can cause additional risk of disruption and distal embolization.

By placing the post-conditioning balloon on the catheter distal to the PTCA balloon, cycling of the post-conditioning balloon will be in an area without coronary artery disease and thus can not cause embolization of any material. Further, the post-conditioning balloon remain transiently inflated after deflation of the PTCA balloon and the debris removed before the restoration of blood flow. The debris can be removed through a lumen in the catheter using vacuum or other similar method known in the literature. Once the debris is removed, the post-conditioning balloon can be deflated and then perform a pattern of post-conditioning inflation/deflation cycles. While the total time prior to restoration of blood flow may be slightly prolonged, the removal of the debris caused by the PTCA may prevent significant additional damage. The balloon 301 can also be shorter and/or made of a different material than the main 105 PTCA balloon and therefore easier to cycle. The balloon 301 can also have a smaller diameter to protect the coronary artery from injury from over-extension.

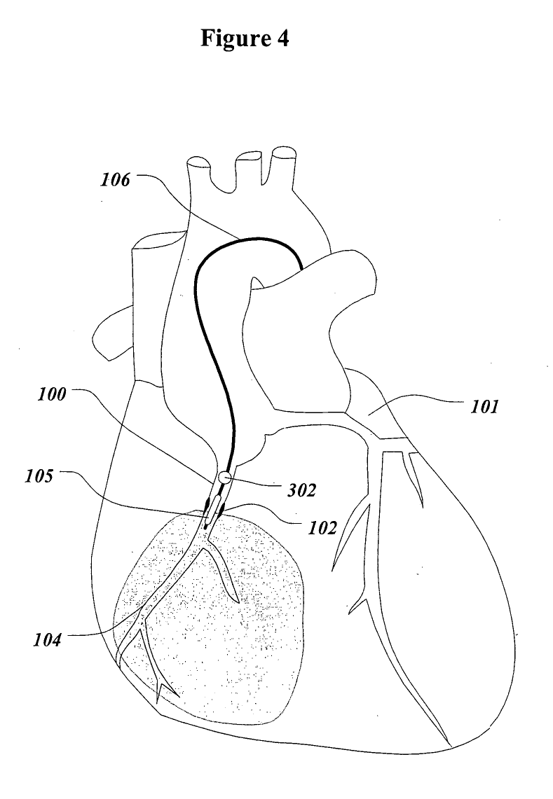

FIG. 4 shows a similar embodiment to that shown in FIG. 3. The post-conditioning balloon 302 is also separate from the dilatation balloon 105 but located proximally on the same catheter shaft. Catheter shaft 106 may incorporate separate inflation lumens for multiple balloons.

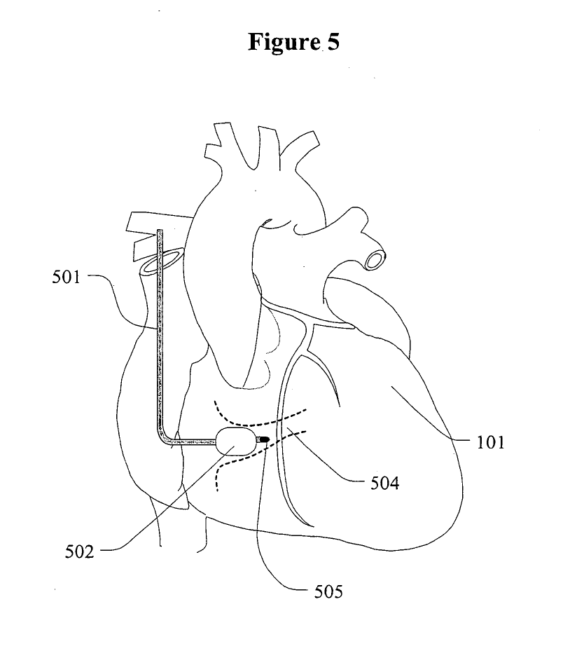

FIG. 5 illustrates an alternative method for post-conditioning of a reperfused heart by obstructing the outflow of coronary blood. Coronary blood flow enters the heart 101 via coronary arteries and exits via coronary veins. The perfusion of the heart can be modulated by obstruction the arterial flow or by backing up the venous flow. There is certain advantage to post-conditioning the heart by obstructing the venous coronary blood flow. It is generally safer and does not interfere with other therapeutic manipulations associated with the catheterization of the coronary artery.

About 80% of coronary blood flow (almost all of the left ventricle blood supply but little of the right coronary blood flow) drains into the coronary sinus 504 of the heart. The coronary sinus is a relatively large appendage that opens into the right atrium of the heart.

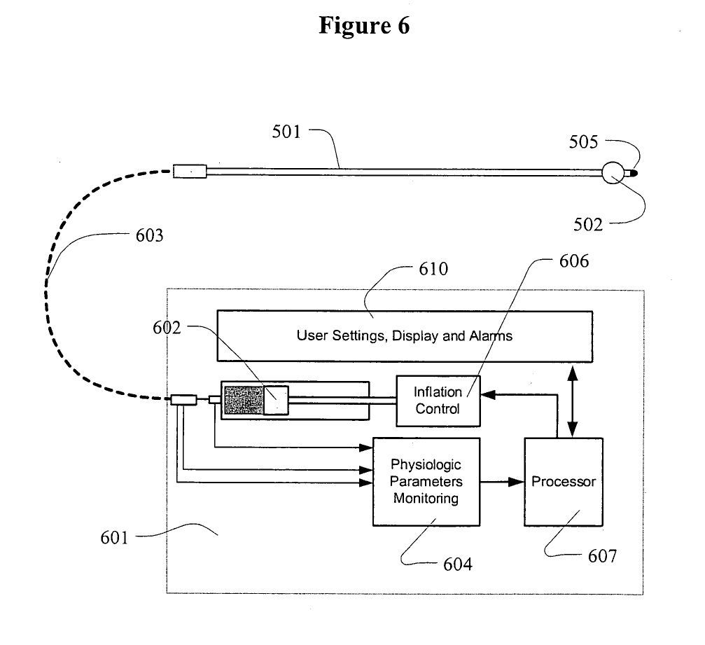

In the preferred embodiment the catheter 501 with an occluding or partially occluding balloon 502 mounted close to the distal catheter tip 505 of the catheter is used to cannulate the Coronary Sinus (CS) 504 of the heart. Both femoral (from below) and jugular (from the top) venous approaches are possible. These approaches are commonly used in the field of invasive cardiology. The catheter is connected to the balloon inflation control system (See FIG. 6). Catheters for Coronary Sinus catheterization and temporary occlusion are known in invasive cardiology. One example of such catheter can be found in the U.S. Pat. No. 6,638,268 to Niazi “Catheter to cannulate the coronary sinus”.

Coronary sinus flow is approximately 200 ml/min in an adult subject. Natural CS blood flow pulsates with the cardiac cycle. It is high during heart diastole and low during systole. Similar to the coronary artery embodiments (See FIGS. 1, 2, 3 and 4) the size of the catheter tip balloon can be manipulated to create graded (partial) occlusion or to intermittently occlude CS following a pattern off occlusion-release as illustrated by FIG. 2.

The balloon 502 inflation and consequently the degree of obstruction to blood flow can be controlled continuously based on the CS pressure feedback to maintain CS pressure within desired physiologic limits. Pressure can be measured using an invasive blood pressure sensor mounted on the tip 505 of the catheter 501. Excessively high CS pressure can lead to angina and ischemia; excessively low CS pressure can result in insufficient post-conditioning. It can be expected that effective CG pressures will be in the range higher than normal venous pressure but lower than normal arterial pressure or, for example, between 10 to 60 mmHg. The CS pressure can be for example gradually reduced from high (for example 50 mmHg) to low (for example 10 mmHg) over the desired period of time (for example 5 to 30 minutes) immediately after PTCA opening of an infarcted coronary artery. Gradual pressure reduction can follow a liner or an exponential trajectory. Controlled occlusion of CS with catheters is known and is described, for example, in the U.S. Pat. No. 4,934,996 to Mohl.

A intermittent (cyclical) or graded (partial) occlusion of the coronary sinus is performed immediately following reperfusion of an acute MI (by re-opening of a coronary artery) to reduce reperfusion injury and ultimately the infarct size.

FIG. 6 schematically shows the elements of the preferred embodiment of the invention related to the monitoring of the patient's CS or Coronary Artery pressure and controlling of the occlusion balloon inflation and deflation. Catheter 501 is equipped with the expandable balloon 502. Proximal end of the catheter is attached to the control and monitoring console 601 by the flexible conduit 603. The inter-connecting elements between the components of the system are simplified on this drawing. It is understood that different lumens inside the catheter can terminate in separate catheter branches and connect to different receptacles on the console 601. The console itself can consist of several separate modules in separate enclosures.

Controller console 601 includes the balloon inflation device 602. Shown in the preferred embodiment is a syringe pump or piston type apparatus. Merit Medical Inc. (South Jordan, Utah) offers a wide variety of these type inflation devices for balloon tipped catheters that can be easily adopted for the invention apparatus. For example Merit Medical manufactures an IntelliSystem® 65 Inflation Syringe for balloon catheters catheter used in cardiology to inflate balloons in coronary arteries of the heart. Alternatively other devices previously used to inflate catheter balloons with compressed gas (such as in Intra-aortic Balloon Pumps) can be used. For example a cylinder with compressed gas under high pressure (not shown) can be connected to the catheter 501 using a pressure regulator and a control valve. Inflation gas can be air, helium or carbon dioxide. Alternatively the balloon 502 can be filled with a liquid such as a radiocontrast agent, saline or water.

Inflation and deflation of the balloon 502 by the inflation device 602 is controlled by the inflation control electronics 606. The inflation control sub-system 602 can include solenoid or other type valves, motors, motor control electronics and common safety features. It is important that it is able to quickly deflate the balloon 502 by withdrawing the piston 602 or opening a safety valve (not shown) and venting the balloon. The actual design of the balloon inflation sub-system is not essential for the invention and can be implemented using known hydraulic and pneumatic elements.

Controller 601 also includes a monitoring sub-system 604. In the preferred embodiment the following physiologic measurements can be made: Coronary Sinus Venous Blood Pressure (CSP) and Coronary Sinus Venous Blood Oxygen Saturation (CSvO2). In the preferred embodiment sensors integrated with the catheter tip 505 are used to make actual measurements. Advanced micro tip catheter blood pressure transducers (such as ones manufactured by Millar Instruments Inc. Houston, Tex.) can be integrated with the catheter to obtain reliable and accurate measurements of pressure in the CS of the heart. Alternatively, for a more economic solution, an external sensor can be used with a fluid filled lumen. Signals from sensors are transmitted via thin electric wires or fiber optics (not shown) enclosed inside the catheter 501, the conduit 603 and terminate inside the monitoring electronics (sub-system) 604.

Physiologic signals from the monitoring sub-system 604 are transmitted to the processor 607 that in turn controls the deflation and (optionally) the inflation of the balloon 502 buy controlling the inflation control system 602. The processor can be a microprocessor equipped with software and memory for data storage (not shown). The user interface sub-system 610 is used to display physiologic information to the user and enable the user to set limits for control and safety algorithms embedded in the processor software. For example the user can request the automatic control of the balloon inflation to maintain mean CS pressure of 20 mmHg for 10 minutes followed by the pressure of 10 mmHg for another 10 minutes.

Implementation of a user requested CS pressure control algorithm could be achieved by applying methods known in the field of controls engineering. For example algorithms such as Proportional Integral (PI) feedback controller can be used to maintain a physiologic parameter (such as CS pressure or CSvO2) or a calculated index at the target level or within the desired range. Control signals can be applied continuously or periodically to adjust the size of the balloon.

It can be expected that during the therapy the balloon can stretch, leak gas or that the patient's condition such as the cardiac contractility, heart rate and peripheral vascular resistance can change. In response to these changes the balloon size (defined by pressure or volume of the infused fluid) may require a correction. It can be envisioned that the operator, based on the readings of physiologic sensors, can make the correction manually. An automatic response has advantage of saved time and increased safety but makes the system more complex and expansive.

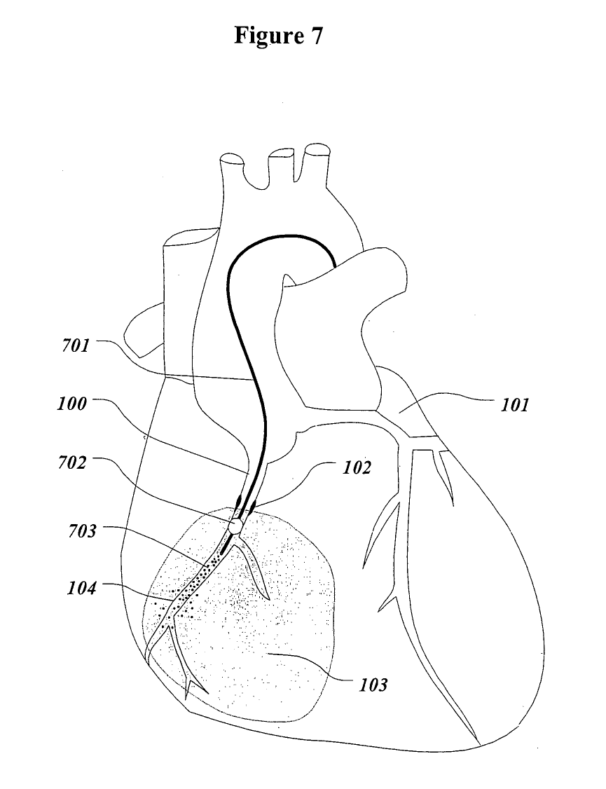

FIG. 7 illustrates post-conditioning of a reperfused heart infarct to prevent or reduce the reperfusion injury by using a perfusate other than normal 100% arterial blood for the duration of the reperfusion injury time that follows reperfusion.

In one preferred embodiment a special perfusion catheter 701 is inserted into the coronary artery 100 immediately following the dilation of the stenosis 102 with a PTCA catheter. The perfusion catheter 701 can be a separate catheter exchanged over the wire to replace the PTCA balloon catheter. The perfusion catheter can also be a PTCA catheter itself equipped with an infusion lumen. The perfusion catheter can also be a hollow guidewire adopted for infusion of the perfusate.

All these types of perfusion, infusion and auto perfusion catheters devices are known in the field of catheter manufacturing. Such catheters were previously used to infuse drugs, blood and blood substitutes into the blood vessels of a heart. One suitable catheter is manufactured by a medical technology company TherOx, Inc. that was founded in 1994 to develop, manufacture, and market minimally invasive products for the delivery of aqueous oxygen to ischemic tissues. TherOx is located in Irvine, Calif. Therox technology is used to deliver aqueous oxygen (AO) solution (oxygen dissolved in physiologic solution at high concentrations) to ischemic tissue of the heart to improve oxygenation. AO contains hyperbaric levels of oxygen and can be delivered through a catheter to targeted locations in the bloodstream. TherOx technology is explained in the U.S. Pat. No. 5,797,876 to Spears and many related patents. The TherOx AO Catheter is a 4.6F sub-selective catheter that easily fits into a large bore 6F guide catheter using an 8F femoral introducer sheath. The AO catheter is 135 cm in length for delivery of hyperoxemic (AO-treated) blood at a rate of 75 cc/minute. The design accommodates standard 0.014″ coronary guide wires, and is intended to pass freely through commercially available guiding catheters. Arterial access can also be achieved contralaterally, utilizing an additional femoral artery stick or a radial artery puncture.

Catheter 701 is equipped with the balloon 702 used to isolate the distal section (branches) 104 of the coronary artery that perfuse the infarct area 103. The perfusate 703 is discharged from the distal end of the catheter 701. Standard perfusion means such as hydration or electronic IV infusion pumps, pressurized IV bags or motorized syringe fluid delivery systems (not shown) can be used to perfuse the infarct zone for up to 60 minutes immediately following the infarct reperfusion. It is expected that perfusate flow of less than 100 ml/min will be sufficient.

Generation of abundant oxygen free radicals during early reperfusion has been implicated as a major player in the heart tissue reperfusion injury. The burst of oxygen-derived free radicals occurs within the first minute and peaks at 4 to 7 min after reperfusion. Several ways are proposed to reduce the damage caused by oxygen free radicals in these critical minutes after reperfusion:

1. Introduction of free radical scavengers,

2. Reperfusion with a perfusate with low oxygen concentration, and

3. Reperfusion with leukocyte-depleted blood

Embodiments illustrated by FIGS. 1 to 6 moderated reperfusion injury by reducing the amount (flow) of oxygenated (generally greater than 90% oxygen saturation) aortic blood that reaches the infarct zone in the reperfusion injury period. The embodiment illustrated by FIG. 7 achieves the same goal by reducing the amount of oxygen-derived free radicals in the infarct zone tissue at the time immediately following reperfusion by changing the perfusate composition. Production of deleterious oxygen-derived free radicals is prompted by the deliver of oxygen (in blood) to the area of the heat previously deprived of oxygen. It is likely that gradual introduction of oxygen to these areas will smoothen the transition, allow tissue to utilize natural defense mechanism (accumulate free oxygen radical scavengers) and ultimately reduce the infarct size and injury.

One way to achieve this goal is to perfuse the infarct zone 103 with the perfusate 703 that contains less oxygen than arterial blood. Such perfusate can be saline (with no oxygen), blood plasma, lactate solution, ringers solution, venous blood (low oxygen content) or a mixture of blood and any suitable physiologic solution similar in composition to blood plasma water. It is important that perfusion of tissue with a perfusate that contains no nutrients or oxygen still accomplishes the goal of removing toxic products of non-aerobic metabolism that accumulate in the heart tissue during ischemia.

One possible therapy algorithm for reperfusion injury can involve the following steps:

1. Reperfusion of MI with a PTCA balloon,

2. Immediately followed by perfusion of the infarct zone with low oxygen perfusate, for example 40% oxygen saturation blood, for up to 60 minutes and likely up to 15-30 minutes, and

3. Perfusion of the infarct zone by normal oxygen saturation perfusate such as the aortic blood.

Steps 2 and 3 of the algorithm can be broken into multiple steps to achieve graded reperfusion. It can be expected that the graded reperfusion will be more beneficial that just two steps. For example, the infarct zone can be reperfused by 20% Oxygen Saturation perfusate for 5 minutes, followed by 40% Oxygen saturation perfusate for 10 minutes, followed by 60% oxygen saturation perfusate for 10 minutes, followed by normal blood perfusion.

Preparation of the perfusate with known controlled oxygen content can be achieved, for example, by mixing normal aortic blood with 95% oxygen saturation with a physiologic fluid such as half normal saline that contains no oxygen. A half blood—half saline mix will produce approximately 45-50% Oxygen saturation perfusate. Mixing can be accomplished outside of the body or inside of the body by adding known amount of saline to the blood inside the targeted coronary artery. For example if blood flow in the coronary artery is 50 ml/min infusing 25 ml/min of saline into the artery will result in approximately 50% reduction of oxygen delivery to the infarct zone.

The balloon 702 can be gradually deflated to gradually allow the flow of the normal arterial blood to be mixed with the oxygen poor perfusate 703 coming out of the tip of the catheter. Alternatively or simultaneously, starting from the time of reperfusion, the flow of the oxygen poor perfusate such as saline can be gradually reduced resulting in a gradually more oxygen rich mix of perfusate entering the infarct zone 103. For example therapy can start by infusing 75 ml/min of normal saline into the coronary artery and gradually reduce flow of saline by 5 ml/min every minute so that after 15 minutes of therapy no saline is pumped into the coronary artery. If the coronary artery 100 is not occluded by the balloon 702 at the end of therapy all the blood flow the infarct zone will come from natural perfusion of the heart with arterial blood. No saline will be added to the perfusate.

The perfusate 703 can be leukocyte-depleted blood of the same patient or a donor. The earliest direct evidence suggesting the involvement of leukocytes in myocardial reperfusion injury was the capillary plugging by leukocytes after myocardial ischemia and reperfusion in dogs reported by Engler and colleagues in 1986. They were also the first to determine the positive effect of leukocyte depletion on the no-reflow phenomenon in canine hearts subjected to ischemia/reperfusion. Several subsequent studies have reported the efficacy of leukocyte-removal filters in attenuation of reperfusion injury.

In one embodiment, blood will be removed from the patient, put though a filter that removes a significant portion of the neutrophils and then used to perfuse the coronary artery, which has the occlusion to be opened or just opened. In one embodiment, blood may be withdrawn from the sheath used for arterial access but may be withdraw from the patient using any other method of arterial or venous access that will provide the desired blood flow for coronary perfusion. The mode of withdrawal may be using gravity or a pump as long as the desired blood flow is achieved. The blood is then passed though a leukocyte-removal filter to remove a clinically advantageous amount of leukocytes from the blood. An example of one such filter is the Cellsorba-80P (Asahi Medical Co).

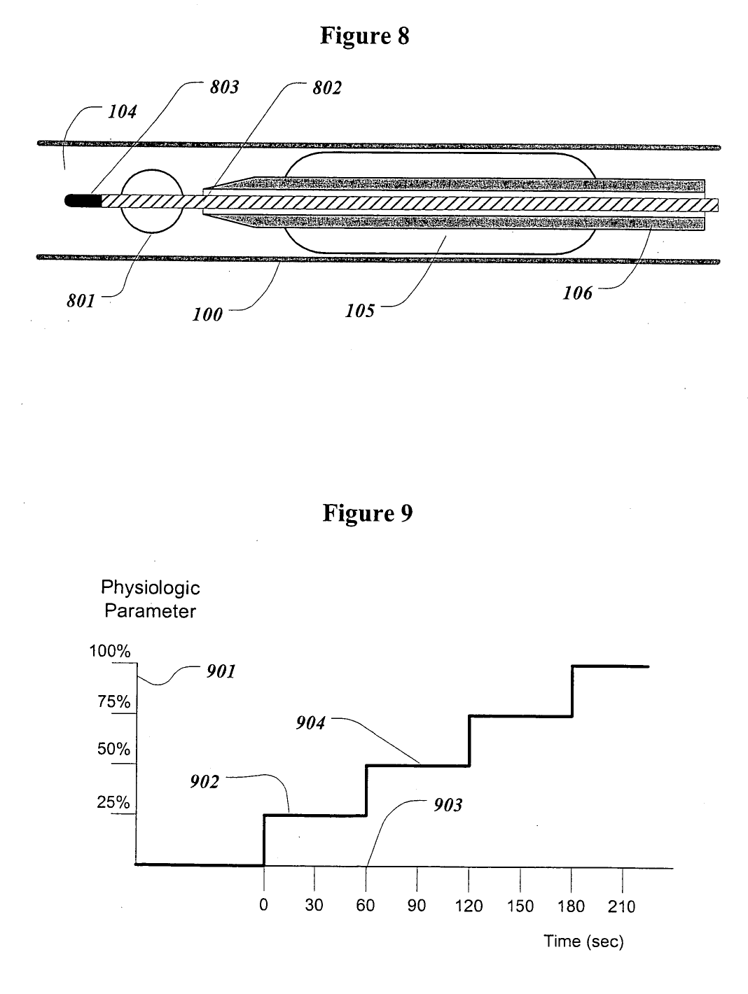

FIG. 8 illustrates one embodiment of post-conditioning using a distal balloon on a guidewire. Primary PTCA balloon catheter 106 is shown inside the coronary artery 100. Special guidewire 802 is inserted into the distal region 104 (downstream) the coronary artery 100. Post-conditioning balloon 801 is mounted on the distal tip of the guidewire 802. It can be inflated and deflated using an internal lumen in the guidewire (not shown). Sensor or sensors 803 at the tip of the guidewire are used to guide the therapy. Sensor 803 can be a pressure sensor or a flow sensor. PTCA guidewires with a tip-mounted balloon and wit tip-mounted micro sensors exist. For example, Radi Medical Systems AB located in Uppsala Sweden manufactures the PTCA diameter 0.014″ guidewire with an integrated tip-mounted pressure sensor. The Radi PressureWire Sensor measures pressure, temperature and coronary blood flow. According to Radi, it also serves as the primary guidewire, as well as a valuable clinical decision-making tool.

Medtronic Corporation (Minneapolis, Minn.) manufactures the GuardWire Temporary Occlusion and Aspiration System that includes a PTCA guidewire with an inflatable blood vessel occlusion balloon mounted on the tip of the wire. The GuardWire System is used for distal protection of small blood vessels fro being emboli zed by debris released by the main angioplasty balloon inflation and deflation.

FIG. 9 illustrates the method of graded reperfusion. Graded (unlike previously discussed intermittent) reperfusion is based on the idea of gradually letting blood flow through the infarct zone after the reopening of the coronary artery. The therapy is guided using a physiologic sensor parameter 901 such as for example blood pressure or blood flow measured by the distal tip sensor 803. The post-conditioning balloon 801 is first inflated to the level of occlusion that corresponds to 25% of normal coronary artery perfusion pressure or flow 901. After the delay 903 of 60 seconds the balloon is deflated somewhat until the second level of 50% is achieved 904. Balloon 801 is held at that level for the second duration of time. It is envisioned that any number of step can be implemented depending on the technology available during the reperfusion injury period of tens of seconds to tens of minutes. With a more sophisticated balloon inflation system a smooth liner or exponential trajectory can be maintained allowing pressure or flow of blood in the distal section 104 of the coronary tree raise smoothly from zero to normal physiologic level minutes after the re-opening of the artery.

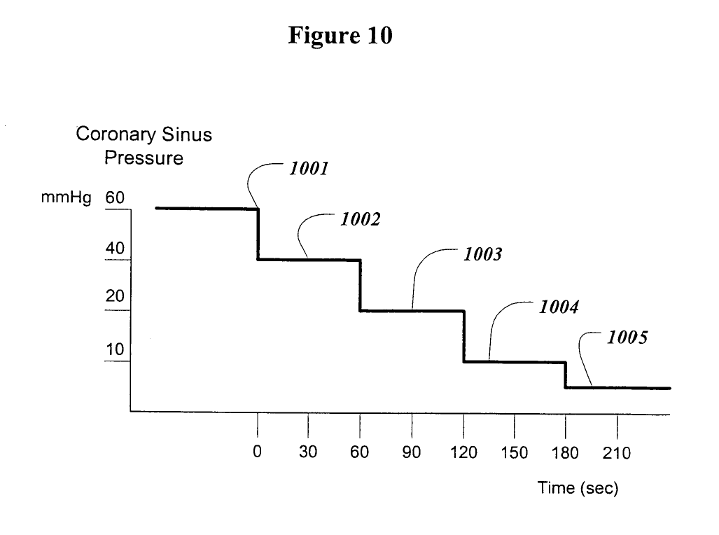

FIG. 10 further illustrates post-conditioning by gradual occlusion of the coronary sinus as shown on the FIG. 5. Unlike previous examples dealing with coronary arteries, the pressure ramp or trajectory starts from its highest value 1001 that may correspond the blood pressure in the totally occluded CS or some value just below it. The balloon 502 (FIG. 5) is maximally extended. When the balloon is released somewhat, pressure is reduced to the level 1002, then to 1003 and 1005. In the end of the ramp 1005 pressure in CS is equal to normal right atrial pressure of that particular patient. At this point the balloon is substantially deflated and is not obstructing drainage of venous blood from the heart.

Common to most of the embodiments disclosed herein is that the flow of blood to the ischemic and infarct-effected regions of the heart is modulated by graded, partial and/or intermittent obstruction of the coronary artery that supplies blood to the infarct area or by partial, and/or graded and/or intermittent obstruction of the coronary sinus or major coronary veins that drain into the coronary sinus. Alternatively, for the duration of therapy, a perfusate fluid that contains less oxygen than normal arterial blood is used to perfuse the reperfused region of the heart. Perfusion can be achieved by diluting blood with a physiologic solution similar in composition to plasma water. Treatment is applied immediately after the reperfusion of the infarct by PTCA or other means and generally for the duration of no more than several hours and preferably tens of minutes.

The invention has been described in connection with the best mode now known to the applicant inventors. The invention is not to be limited to the disclosed embodiment. Rather, the invention covers all of various modifications and equivalent arrangements included within the spirit and scope of the appended claims.

What is claimed is:

1. A method for treating an infarct of a heart in a human patient following reperfusion comprising:
inserting a catheter into a coronary artery of the patient wherein the catheter includes a proximal region and a distal region and the distal region further comprises an expandable member, and
cyclically expanding and reducing the expandable member to modulate the distal coronary blood flow.

2. The method of claim 1 wherein the modulated blood flow is to an area of a heart area at risk for infarction.

3. The method of claim 1 wherein the cyclical expansion and reduction occurs at least once every 60 seconds.

4. The method of claim 1 wherein the expansion occurs for longer periods than the reduction.

5. The method of claim 1 wherein the reduction occurs for longer periods than the reduction.

6. The method of claim 1 wherein the reduction comprises a partial reduction of the expandable member.

7. The method of claim 1 further comprising a second expandable member arranged on the distal end of the catheter and expanding the second expandable member to open blockage in the coronary.

8. The method of claim 1 wherein the expandable member is mounted on the distal region.

9. A method for treating a reperfusion injury of an organ in a human patient resulting from an occluded artery comprising:
opening the occluded artery;
reperfusing the organ;
inserting a catheter into the artery the catheter having a proximal region, a distal region and an expandable member attached to the distal region, and
repeatedly expanding and reducing the expandable member.

10. The method of claim 9 wherein the expansion and reduction is performed to modulate blood flow to the organ.

11. The method of claim 9 wherein the expansion and reduction modulates a distal coronary venous blood flow.

12. A method for treating an infarct of a heart in a human patient following reperfusion comprising:
inserting a catheter into a coronary artery of the heart of the patient, and
infusing into the coronary artery a perfusate with reduced oxygen content.

13. A method of claim 12 wherein the perfusate is diluted blood

14. A method of claim 12 wherein the perfusate is venous blood

15. A method of claim 12 wherein the perfusate is a blood substitute.

16. A method for treating a reperfusion injury of an organ in a human patient resulting from an occluded artery during acute myocardial infarction (MI) comprising:
opening the occluded artery in response to the MI;
positioning a balloon catheter in the re-opened coronary vessel, and
modulating a size of the balloon catheter to modulate arterial coronary blood flow distal of the re-opened occlusion.

17. The method of claim 17 wherein the balloon modulates venous coronary blood flow in the coronary sinus.

18. The method of claim 16 further comprising performing a primary coronary angioplasty.

19. The method of claim 16 wherein the size of the modulated balloon is periodically varied to modulate the blood flow.

20. The method of claim 16 wherein the balloon catheter is positioned in the coronary vessel for less than five hours.
